(19) United States
(12) Patent Application Publication
(10) Pub. No.: US 2018/0330438 A1
(43) Pub. Date: Nov. 15, 2018

(54) Trading System with Natural Strategy Processing, Validation, Deployment, and Order Management in Financial Markets

(71) Applicants: Vipul Divyanshu, Bengaluru (IN); Jayalakshmi Manohar, Bengaluru (IN); Harsha Manohar, Bengaluru (IN)

(72) Inventors: Vipul Divyanshu, Bengaluru (IN); Jayalakshmi Manohar, Bengaluru (IN)

(21) Appl. No.: 15/978,082

(22) Filed: May 11, 2018

Related U.S. Application Data
(60) Provisional application No. 62/504,864, filed on May 11, 2017.

(51) Int. Cl. G06Q 40/04; G06Q 40/06; G06Q 30/02; G10L 15/26; G06T 11/20; G06F 17/28; G06N 7/00; G06N 3/02

(52) U.S. Cl. CPC G06Q 40/04; G06Q 40/06; G06Q 30/0201; G10L 15/26; G10L 21/0208; G06F 17/2881; G06N 7/005; G06N 3/02; G06T 11/206

(57) ABSTRACT

A trading system with natural strategy processing, validation, deployment, and order management in financial markets to manage security transactions on the financial market on behalf of the user. The trading system receives a trading strategy from the user. The trading strategy is a raw input, such as a text input, a video input, an audio input, an image input, or a combination thereof for the user's. The trading strategy is transformed from the raw input into a logical text string, that is parsed and organized into a custom trade-strategy code block. The custom trade-strategy code block is validated using external data, such as historical data or live market data. The custom trade-strategy code block executes the trade order onto the financial market. Graphical representations from executing the custom trade-strategy code block are generated to display the results to the user, such that the user can make informed market decisions.

The current application claims a priority to the U.S. Provisional Patent application Ser. No. 62/504,864 filed on May 11, 2017.

### FIELD OF THE INVENTION

The present invention relates generally to a financial market trading system. More specifically, the present invention relates to the generation of customized trading systems by receiving natural input from a user to generate trade orders on behalf of the user.

### BACKGROUND OF THE INVENTION

Trading on the electronic stock exchanges, such as the National Association of Securities Dealers Automated Quotations (NASDAQ) and Multi Commodity Exchange of India Ltd (MCX), has increased in the recent years. Brokers, who facilitate such trades, provide trading terminals to clients of the broker. Traders use these trading terminals to place buy or sell orders for securities. These trading terminals historically provide an interface through which a user can view the price at which a security is trading and directly place a buy or sell order by keying in the name and price of the security or a derivative of the name. Due to recent advances in technology, some of these trading terminals also provide additional tools such as charting tools, where the price of the security is represented visually as a chart. Some terminals also provide charting tools where the user can view and apply certain technical indicators, such as moving averages, oscillators, overlap studies. These tools allow a trader to make decisions using additional information to the price of the security. However, the scope of such tools is limited. For instance, slightly complex trading models, such as such as “Buy 500 shares of Apple Inc. (AAPL), when twitter sentiment on new iPhone is extremely positive and the relative strength index crosses above 40,” are not possible to create. These tools do not provide the ability to validate the trading systems. To place a trade using this information, the terminals still rely on user input to decide whether to submit an order. The decisions are based on the user's intellect and perception of the trading opportunity without any mathematical validation to support this perception. Once the user submits an order to enter a trade, the trading terminal requires the user to constantly monitor the fluctuating price of the security.

Therefore, most traders place such trade orders in the market based on instinct. Studies have shown that lack of discipline and subjective trading leads most retail and novice traders make staggering losses in the stock market. On the other hand, with advances in technology, the number of trades placed by computer algorithms is on the rise. Large institutional investors, for example, have extensive computing and programming resources and build trading systems to perform large and complex computations with the help of computer code and engineers.

These algorithms place trade orders based on intricate models using technical indicators, price actions, or various mathematical models that a human being will not be able to compute efficiently. These models require processing large amounts of data such as open, high, low, and close prices of the securities every minute or from historical pricing data. Several securities that span across a plurality of time frames need to be aggregated, processed, and modeled using mathematical formulae, neural network models, or any other data processing method before arriving at a trading decision.

In order to create and use such custom trading systems, a user is required to build a trading system using computer understandable programming languages, and model the systems by coding the mathematical models, technical indicators, or any other trading logic. The trading system will compute the large volumes of data and output trading orders to be placed automatically or by the user on the electronic stock exchange.

An individual who does not have the ability or knowledge of computer programming languages will not be able to build such trading systems. Therefore, trades are often placed based on prices, visually perceived chart data, or instinctive gut feel. Market competition is fierce and trading without using a trading system increases risk and reduces profitability.

Without assistance from computerized trading systems and engineers, some people will not be able to program such trade systems and validate a trading model by assessing the profitability and risk potential of any trading decision derived from it using methods, such as backtesting testing and forward testing. Backtesting refers to the process through which a system trades hypothetically using the trading model on historical market data and generates metrics that validate the trading system. Forward testing is the process to simulate the results of the trading model in a live market in order to validate the trade system. These validated trade systems are generally not possible to be deployed to trade in the market with live security data.

Therefore, an objective of the present invention is to provide a system that allows users that do not possess the ability to draft computer code, to access extensive computing resources, and/or to access engineering resources to be able to achieve algorithmic trading. The present invention allows trading systems to be built at lower costs, faster speeds, and using less expertise than traditional trading systems.

### BRIEF DESCRIPTION OF THE DRAWINGS

FIG. 1 is a flow diagram for the general steps of the present invention.

FIG. 2 is a flow diagram for an embodiment of the present invention, wherein the user is prompted for a strategy input with a data processing device.

FIG. 3 is a flow diagram for an embodiment of the present invention, wherein the user is prompted for the strategy input with a remote computing device.

FIG. 4 is a flow diagram for an embodiment of the present invention, wherein the strategy input is a text input.

FIG. 5 is a flow diagram for an embodiment of the present invention, wherein the strategy input is an audio input.

FIG. 6 is a flow diagram for an embodiment of the present invention, wherein the strategy input is a video input.

FIG. 7 is a flow diagram for an embodiment of the present invention, wherein the strategy input is an image input.

FIG. 8 is a flow diagram for an embodiment of the present invention, wherein the validation algorithm includes a backtesting module.

FIG. 9 is a flow diagram for an embodiment of the present invention, wherein the validation algorithm includes a forward testing module.

FIG. 10 is a flow diagram detailing the deployment algorithm of the present invention.

FIG. 11 is a flow diagram of the present invention detailing the risk-assessment algorithm.

### DETAIL DESCRIPTIONS OF THE INVENTION

All illustrations of the drawings are for the purpose of describing selected versions of the present invention and are not intended to limit the scope of the present invention.

The present invention is a trading system with natural strategy processing, validation, deployment, and order management in financial markets. The present invention allows users a means to effectively engage in market trading. With the present invention, users will be able to implement a trading strategy that is customized to the user's preferences. Even users who do not possess computer coding or financial trading experience will be able to develop, validate, implement, and view the results of customizable trading strategies.

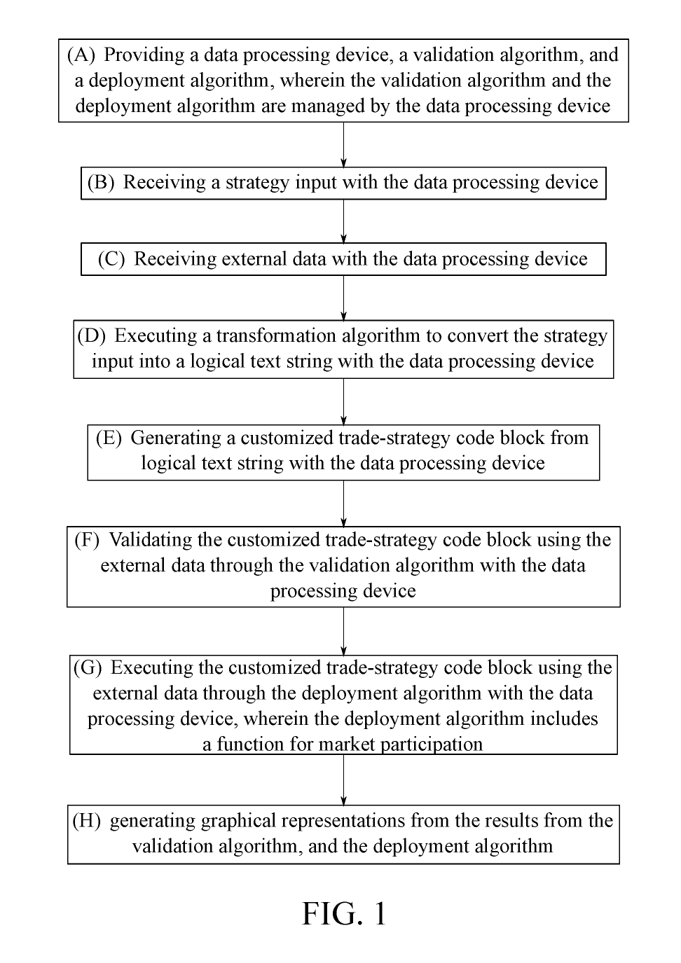

The present invention is executed requiring the use of a data processing device, a validation algorithm, and a deployment algorithm (Step A), shown in FIG. 1. The data processing device is a computing device, such as a server or personal computing device, that is capable of translating user input into executable trade systems. Additionally, the data processing device can model the trade systems using large quantities of financial data to validate the trade system with historical and current market behaviors with the validation algorithm and execute the trade system on a live market with the deployment algorithm. The data processing device manages the validation algorithm and the deployment algorithm.

In accordance to FIG. 1, a strategy input is initially received with the data processing device (Step B). The strategy input is a raw text input, audio input, video input, image input or combination thereof that includes the user's intended actions for stock transactions on the market. Simultaneously, external data is received with the data processing device (Step C). The external data includes, but is not limited to, historical market data, current market data, fundamental data, news sources, or market sentiment data to be compiled into the validation algorithm, in order to validate a generated trade system using real market data and investor sentiments. Historical market data includes past trading patterns for a product. Current market data is relates to recent trading patterns for the product. Fundamental data refers to any data besides trading patterns that might impact the value of the securities. News sources refer to any data obtainable from news outlets mentioning the product. Market sentiment is any data from social media or other forums that provides insight into how the product is received by the public. In addition, the external data may be used to derive trade orders to be implemented in a live market.

A transformation algorithm is then executed to convert the strategy input into a logical text string with the data processing device (Step D). The transformation algorithm converts the strategy input from a raw format into a string of text that is able to be processed using the data processing device. A customized trade-strategy code block is then generated from the logical text string with the data processing device (Step E). The customized trade-strategy code block is a plurality of subroutines to manage financial transactions on a live market, such as the National Association of Securities Dealers Automated Quotations (NASDAQ) or the Multi Commodity Exchange of India Ltd (MCX). The customized trade-strategy code block is then validated using the external data through the validation algorithm with the data processing device (Step F), in order to ensure the customized trade-strategy code block will behave consistently and favorably when applied to the live market. The customized trade-strategy code block is then executed using the external data through the deployment algorithm with the data processing device, wherein the deployment algorithm includes a function for market participation (Step G), such that the customized trade-strategy code block facilitates scheduled or real-time trading with the live market.

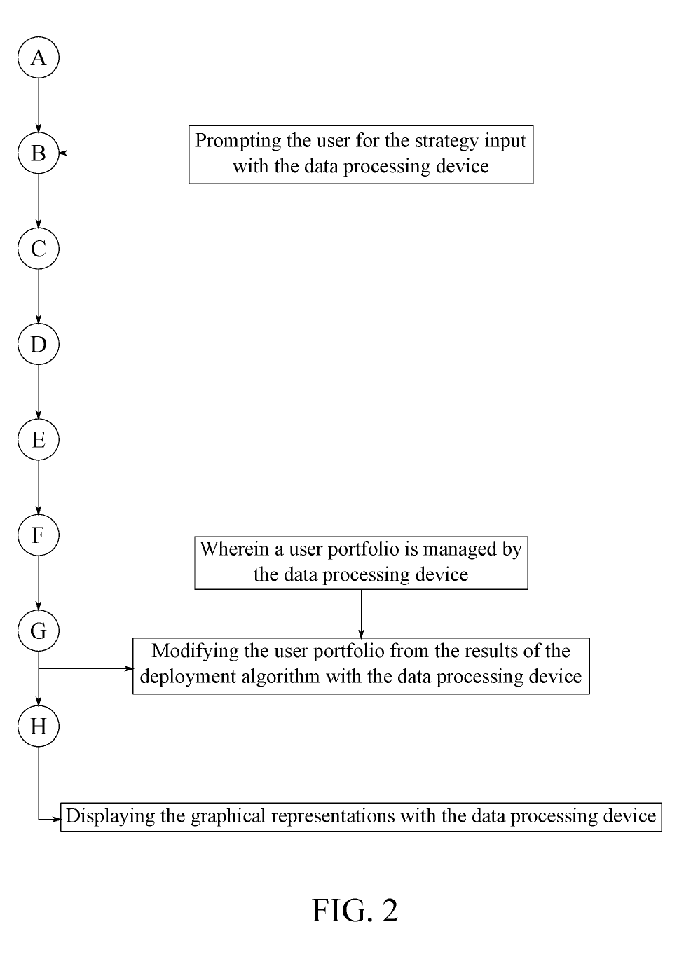

In some embodiments of the present invention, the user is prompted for the strategy input with the data processing device, directly, as shown in FIG. 2. In this embodiment, the user is able to process the strategy input locally, removing any network delay from transferring the strategy input and the graphical representations to and from the remote computing device. After Step H, the graphical representations are displayed with the data processing device, in order for the user to assess the results from the validation algorithm and the deployment algorithm.

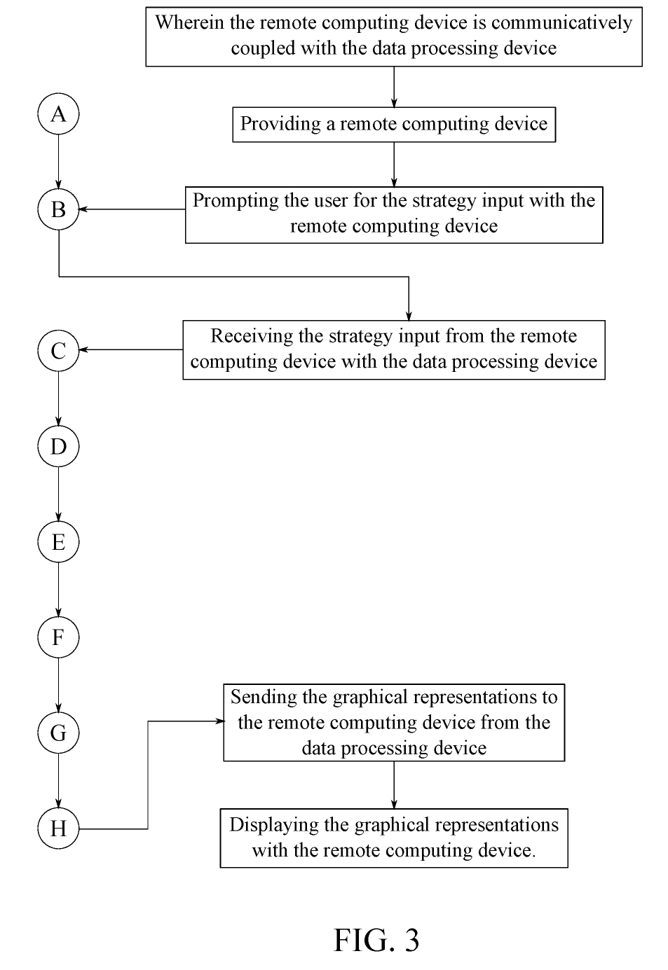

For some embodiments of the present invention, the present invention utilizes a remote computing device to provide the user with access to the data processing device remotely, in accordance to FIG. 3. The remote computing device allows the user to interface with the present invention and submit strategy inputs to the data processing device; however, the present invention utilizes the processing power of the data processing device to execute the validation algorithm and the deployment algorithm. The remote computing device is communicatively coupled with the data processing device in order to send strategy inputs to the data processing device and receive graphical representations for the validation and execution of the strategy input. The user is prompted for the strategy input with the remote computing device, prior to Step B. Once the user inputs the strategy input, the strategy input is then received from the remote computing device with the data processing device, during Step B. After Step H, the graphical representations are sent to the remote computing device from the data processing device. The graphical representations are then displayed with the remote computing device in order for the user to assess the results from the validation algorithm and the deployment algorithm.

Further in accordance to the preferred embodiment, a user portfolio is managed by the data processing device, shown in FIG. 2. The user portfolio stores data, including but not limited to the user's capital, securities, trading history, profits, and losses. The user portfolio is modified using the results of the deployment algorithm with the data processing device, after Step G. Regularly updating the user portfolio maintains the accuracy for the data of the user portfolio and modeling based on user behavior.

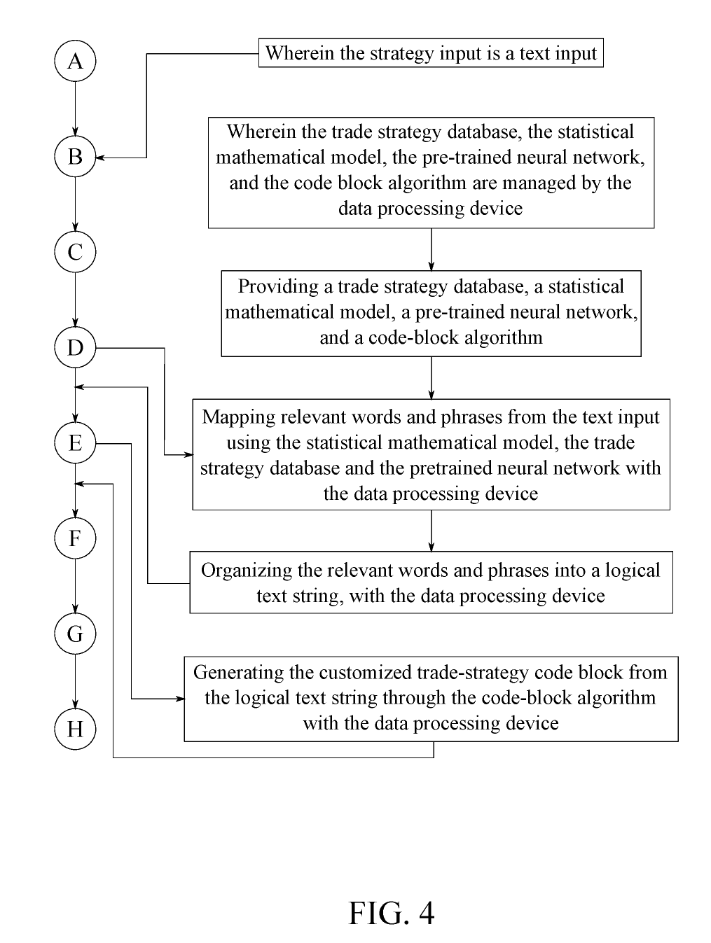

In accordance to the preferred embodiment of the present invention, the present invention implements a trade-strategy database, a statistical mathematical model, a pre-trained neural network, and a code-block algorithm, wherein the trade strategy database, the statistical mathematical model, the pre-trained neural network, and the code block algorithm are managed by the data processing device, detailed in FIG. 4 to FIG. 7. The trade-strategy database, the statistical mathematical model and the pre-trained neural network are used to isolate key components from the strategy input. Additionally, the statistical mathematical model and the pre-trained neural network can determine any missing words or phrases that may be relevant and necessary to the user's intended trade strategy. The code-block algorithm organizes the key components from the strategy input into executable code.

In some embodiments of the present invention, the present invention executes additional steps to convert the strategy input into a parsable format with the transformation algorithm dependent on the media that the strategy input. Wherein the strategy input is a text input, relevant words and phrases are mapped from the text input using the statistical mathematical model, the trade strategy database, the statistical mathematical model and the pre-trained neural network with the data processing device, during Step D, detailed in FIG. 4. The relevant words and phrases are then organized into a logical text string with the data processing device in order to parse the relevant words and phrases with the code-block algorithm. The custom trade-strategy code block is then generated from the logical text string through the code-block algorithm with the data processing device, during Step E, to produce the executable code from the user's trading strategy.

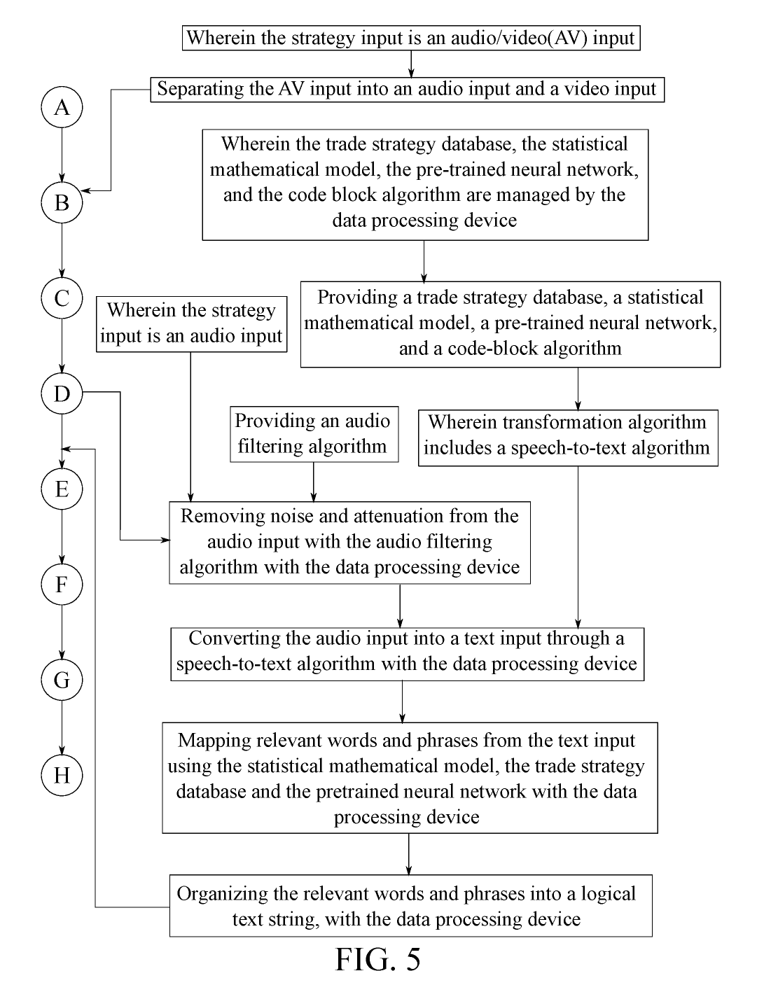

For embodiments of the present invention where the strategy input is an audio input, in accordance to FIG. 5. The audio input is converted into a text input through a speech-to-text algorithm with the data processing device, during Step D, wherein the transformation algorithm includes the speech-to-text algorithm. If necessary, for some more specific embodiments of the present invention, an audio filtering algorithm is utilized in order to clarify the audio input to increase the accuracy of the speech-to-text algorithm. Noise and attenuation is removed from the audio input with the audio filtering algorithm with the data processing device. The audio filtering algorithm utilizes band-pass filter to reject frequencies outside of a certain range to clarify the audio input before the audio input is converted into the text input more accurately. Relevant words and phrases are then mapped from the text input using the statistical mathematical model, the trade strategy database, the statistical mathematical model and the pre-trained neural network with the data processing device. The relevant words and phrases are then organized into a logical string with the data processing device in order to parse the relevant words and phrases with the code-block algorithm. The custom trade-strategy code block is then generated from the logical text string through the code-block algorithm with the data processing device, during Step E, to produce the executable code from the user's trading strategy.

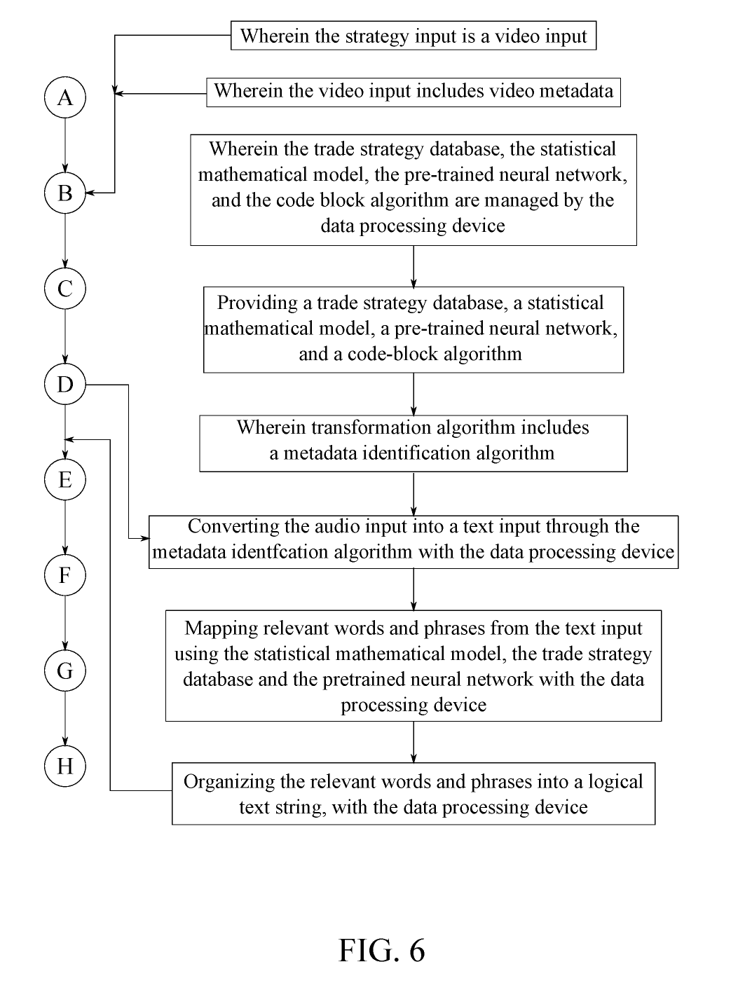

In embodiments of the present invention wherein the strategy input is a video input and wherein the video input includes video metadata, the video metadata is used to identify relevant words or phrases to the user's trade strategy, detailed in FIG. 6. The video metadata is converted into a text input using a metadata identification algorithm with the data processing device, wherein the transformation algorithm includes the metadata identification algorithm, during Step D. The metadata identification algorithm extracts data tags associated with the video input into the text input. Relevant words and phrases are mapped from the text input using the statistical mathematical model, the trade strategy database, the statistical mathematical model and the pre-trained neural network with the data processing device. The relevant words and phrases are then organized into a logical string with the data processing device in order to parse the relevant words and phrases with the code-block algorithm. The custom trade-strategy code block is then generated from the logical text string through the code-block algorithm with the data processing device, during Step E, to produce the executable code from the user's trading strategy.

In other embodiments of the present invention, the strategy input is an audio/video (AV) input, shown in FIG. 5. The AV input is separated into an audio input and a video input then transformation algorithm is applied to both the audio input and the video input individually, as previously described, and then combined to generate an amalgamated customized trade-strategy code block to more accurately generate the trade strategy intended by the user.

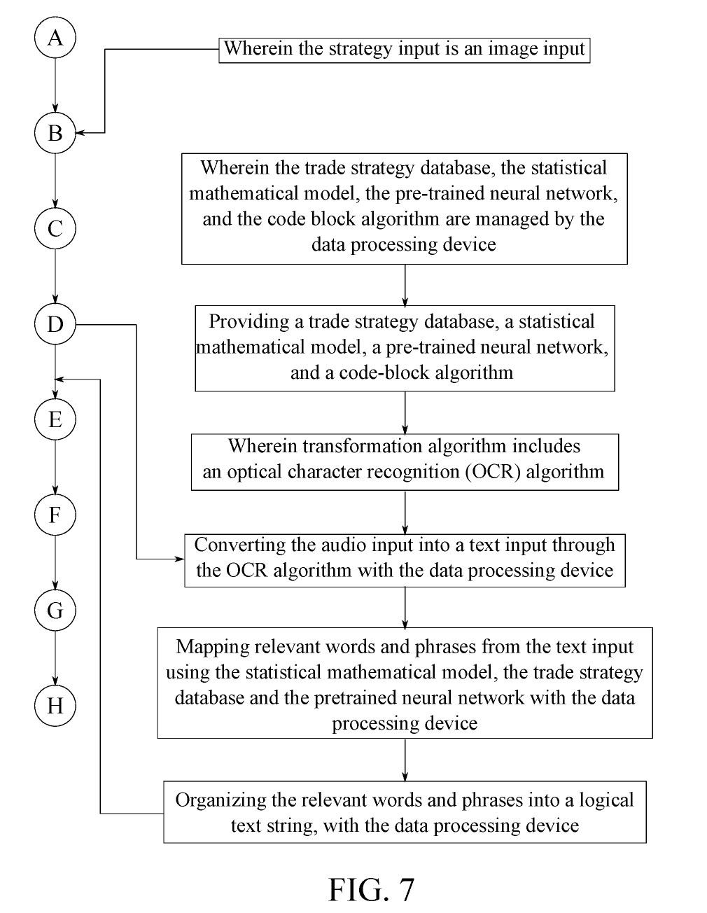

For embodiments of the present invention where the strategy input is an image input, detailed in FIG. 7. The image input is converted into a text input using an optical character recognition (OCR) algorithm with the data processing device, during Step D, wherein the transformation algorithm includes the OCR algorithm. The OCR algorithm identifies text within the image input to produce the text input. Relevant words and phrases are then mapped from the text input using the statistical mathematical model, the trade strategy database, the statistical mathematical model and the pre-trained neural network with the data processing device. The relevant words and phrases are then organized into a logical string with the data processing device in order to parse the relevant words and phrases with the code-block algorithm. The custom trade-strategy code block is then generated from the logical text string through the code-block algorithm with the data processing device, during Step E, to produce the executable code from the user's trading strategy.

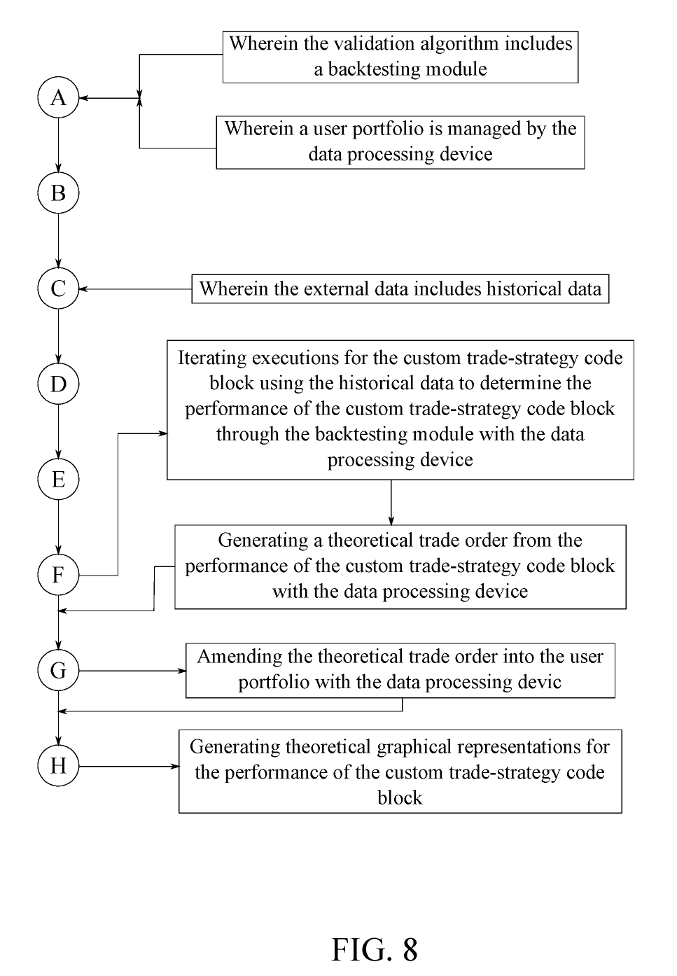

Still in accordance to the preferred embodiment, the validation algorithm includes a backtesting module, illustrated in FIG. 8. The backtesting module implements historical data included within the external data to validate the custom trade-strategy code block. Executions for the custom trade-strategy code block are iterated using the historical data to determine the performance of the custom trade-strategy code block through the backtesting module with the data processing device, during Step F, to determine the validity for the custom trade-strategy code block. A theoretical trade order is generated from the execution of the custom trade-strategy code block with the data processing device. The theoretical trade order is then amended into the user portfolio with the data processing device, such that the theoretical trade order may be considered by the user when the user interacts with the live market. Theoretical graphical representations for the performance of the customized trade strategy are generated, during step H, in order to display the performance of the customized trade strategy for the user's consideration.

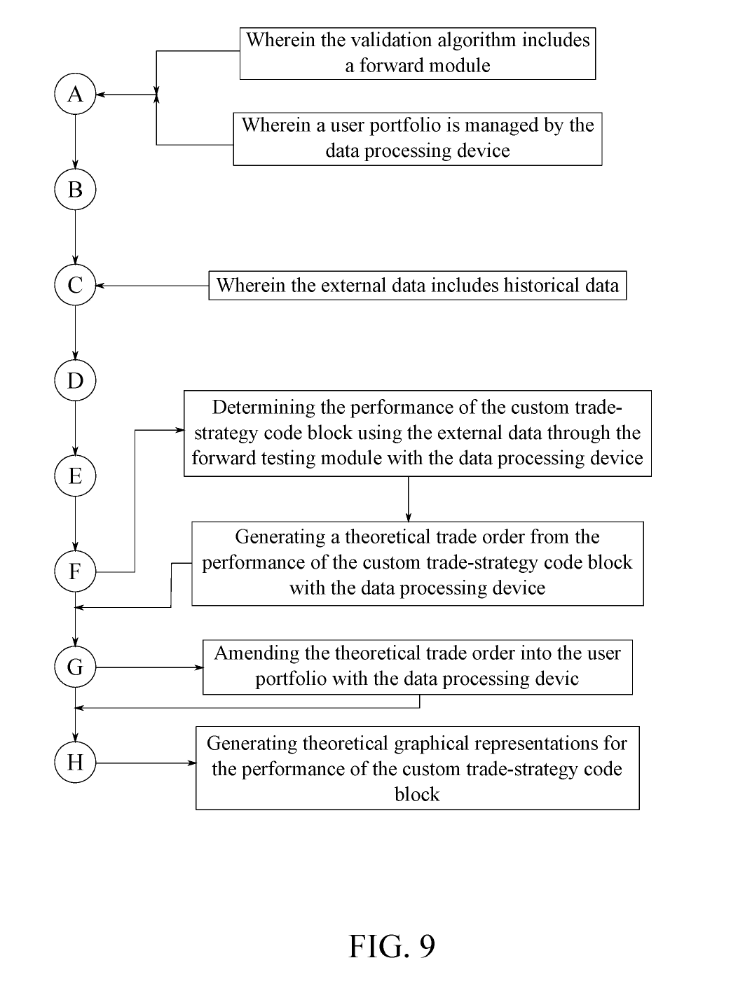

In additional embodiments of the present invention, the validation algorithm includes a forward testing module, shown in FIG. 9. The forward testing model validates the custom trade-strategy code block using current market data. The performance of the custom trade-strategy code block is determined using the external data through the forward testing module with the data processing device, during Step F. The theoretical trade order is then amended into the user portfolio with the data processing device, such that the theoretical trade order may be considered by the user when the user interacts with the live market. Theoretical graphical representations for the performance of the customized trade strategy are generated, during step H, in order to display the performance of the customized trade strategy for the user's consideration.

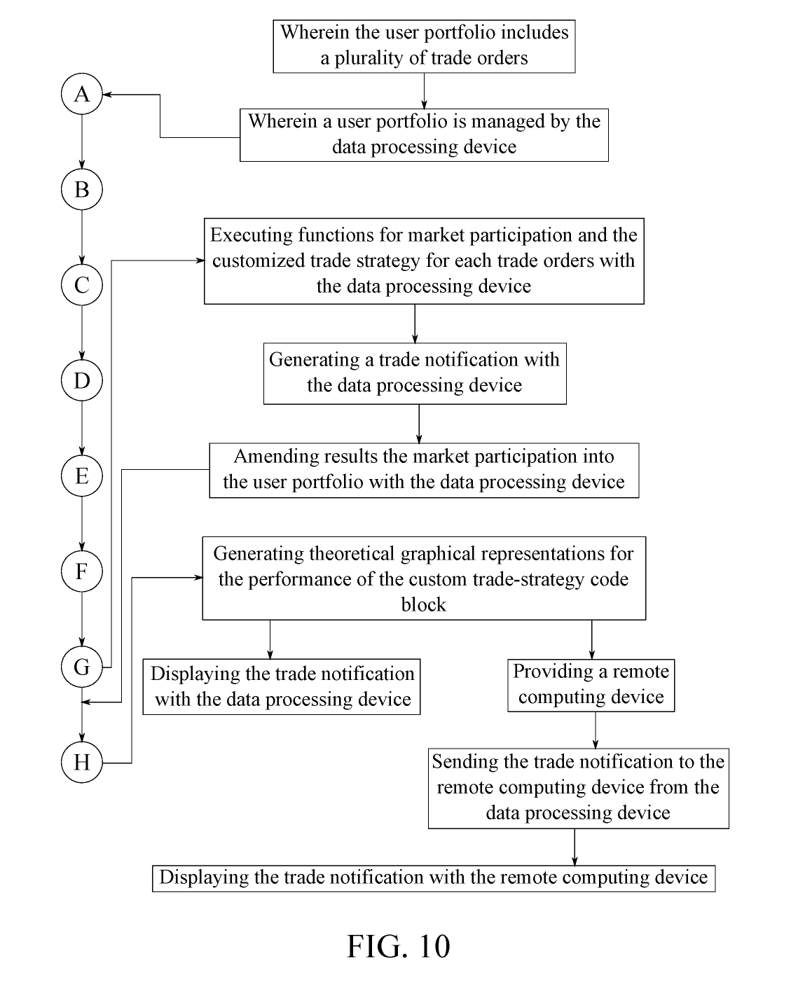

In practice, the user portfolio includes a plurality of trade orders for transactions to be made with the live market, detailed in FIG. 10. The functions for market participation and the customized trade strategy are executed for each trade orders with the data processing device in order to engage the live market and exchange securities to and from the user portfolio. A trade notification is generated with the data processing device, in order to alert the user that the transaction for any given trade order occurred. In some embodiments of the present invention, the trade notification is displayed to the data processing device, such that the user is able to view the trade notification. In some other embodiments of the present invention, the trade notification is sent to the remote computing device with from the data processing device. The trade notification is then displayed with the remote computing device, such that the user is able to view the trade notification. The results for the market participation are amended into the user portfolio with the data processing device, in order to maintain an accurate account of the securities and capital stored within the user portfolio. Graphical representations are generated from the market participation, during Step H, such that the user is able to view metrics for the performance of the market participation.

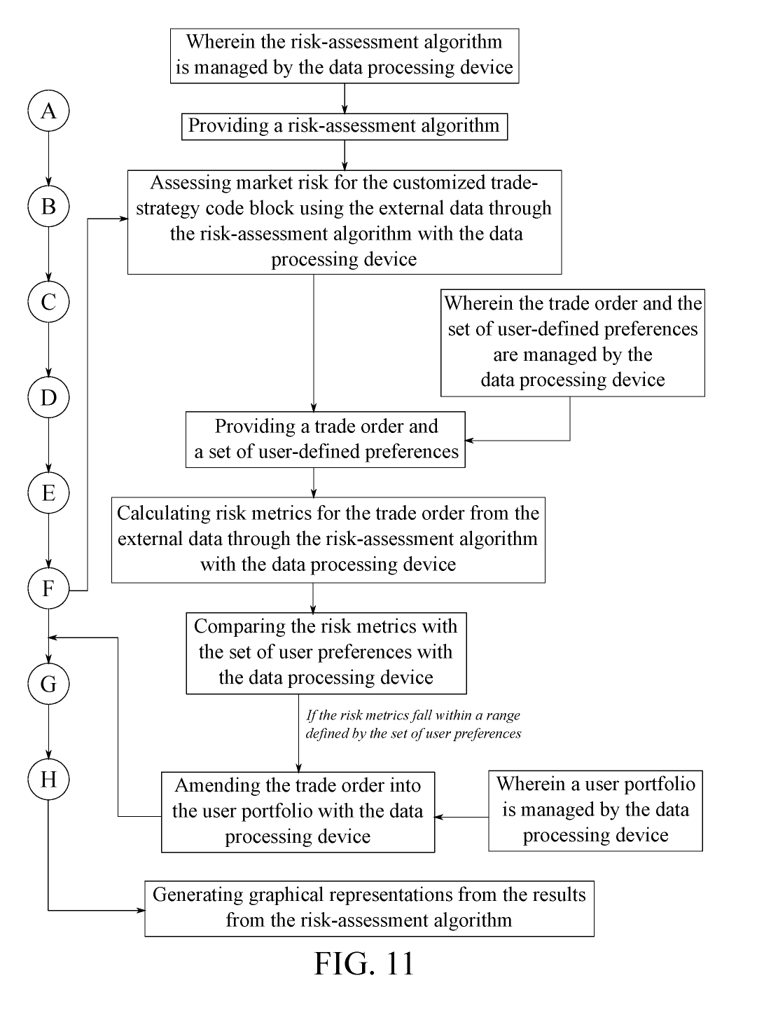

Further in accordance to the preferred embodiment of the present invention, the present invention implements a risk-assessment algorithm, wherein the risk-assessment algorithm is managed by the data processing device, illustrated in FIG. 11. The risk-assessment algorithm provides the user with information for the probability for potential losses when executing a trade on the live market at the given time. Market risk is assessed for the customized trade-strategy code block using the external data through the risk-assessment algorithm with the data processing device, prior to Step G. Graphical representations are generated from the results from the risk-assessment algorithm, during Step H, in order to display the results of the risk-assessment algorithm to the user.

Given a trade order and a set of user-defined preferences, wherein the set of user-defined preferences are managed by the data processing device, the user is able to filter trade orders based on the potential risk of losses for each trade order with the set of user-defined preferences. Risk metrics are calculated for the trade order from the external data through the risk-assessment algorithm with the data processing device, in order to determine the risk for the particular market associated with the external data. The risk metrics are then compared with the set of user preferences with the data processing device in order to determine if the trade order complies with the set of user preferences. The trade order is amended into the user portfolio with the data processing device, if the risk metrics fall within a range defined by the set of user preferences. Once the trade order is amended into the user portfolio, the trade order is executed on the live market through the deployment algorithm.

Although the invention has been explained in relation to its preferred embodiment, it is to be understood that many other possible modifications and variations can be made without departing from the spirit and scope of the invention as hereinafter claimed.

What is claimed is:

1. A trading system with natural strategy processing, validation, deployment, and order management in financial markets comprises the steps of:
(A) providing a data processing device, a validation algorithm, and a deployment algorithm, wherein the validation algorithm and the deployment algorithm are managed by the data processing device;
(B) receiving a strategy input with the data processing device;
(C) receiving external data with the data processing device;
(D) executing a transformation algorithm to convert the strategy input into a logical text string with the data processing device;
(E) generating a customized trade-strategy code block from logical text string with the data processing device;
(F) validating the customized trade-strategy code block using the external data through the validation algorithm with the data processing device;
(G) executing the customized trade-strategy code block using the external data through the deployment algorithm with the data processing device, wherein the deployment algorithm includes a function for market participation; and
(H) generating graphical representations from the results from the validation algorithm, and the deployment algorithm.

2. The trading system with natural strategy processing, validation, deployment, and order management in financial markets, as claimed in claim 1, comprises the steps of:
providing a remote computing device, wherein the remote computing device is communicatively coupled with the data processing device;
prompting the user for the strategy input with the remote computing device, prior to Step B; and
receiving the strategy input from the remote computing device with the data processing device, during Step B.

3. The trading system with natural strategy processing, validation, deployment, and order management in financial markets, as claimed in claim 1, comprises the step of:
prompting the user for the strategy input with the data processing device, prior to Step B.

4. The trading system with natural strategy processing, validation, deployment, and order management in financial markets, as claimed in claim 1, comprises the steps of:
providing a remote computing device, wherein the remote computing device is communicatively coupled with the data processing device;
sending the graphical representations to the remote computing device from the data processing device, after to Step H; and
displaying the graphical representations with the remote computing device.

5. The trading system with natural strategy processing, validation, deployment, and order management in financial markets, as claimed in claim 1, comprises the step of:
displaying the graphical representations with the data processing device, after Step H.

6. The trading system with natural strategy processing, validation, deployment, and order management in financial markets, as claimed in claim 1, comprises the steps of:
wherein a user portfolio is managed by the data processing device; and
modifying the user portfolio from the results of the deployment algorithm with the data processing device, after Step G.

7. The trading system with natural strategy processing, validation, deployment, and order management in financial markets, as claimed in claim 1, comprises the steps of:
providing a trade strategy database, a statistical mathematical model, a pre-trained neural network, and a code-block algorithm, wherein the trade strategy database, the statistical mathematical model, the pre-trained neural network, and the code block algorithm are managed by the data processing device;
wherein the strategy input is a text input;
mapping relevant words and phrases from the text input using the statistical mathematical model, the trade strategy database and the pretrained neural network with the data processing device, during Step D;
organizing the relevant words and phrases into a logical text string, with the data processing device; and
generating the customized trade-strategy code block from the logical text string through the code-block algorithm with the data processing device, during step E.

8. The trading system with natural strategy processing, validation, deployment, and order management in financial markets, as claimed in claim 1, comprises the steps of:
providing a trade strategy database, a statistical mathematical model, a pre-trained neural network, and a code-block algorithm, wherein the trade strategy database, the pre-trained neural network, the statistical mathematical model, and the code-block algorithm are managed by the data processing device;
wherein the strategy input is an audio input;
converting the audio input into a text input through a speech-to-text algorithm with the data processing device, during Step D, wherein transformation algorithm includes the speech-to-text algorithm;
mapping relevant words and phrases from the text input using the statistical mathematical model, the trade strategy database and the pretrained neural network with the data processing device;
organizing the relevant words and phrases into a logical text string, with the data processing device; and
generating the customized trade-strategy code block from the logical text string through the code-block algorithm with the data processing device, during step E.

9. The trading system with natural strategy processing, validation, deployment, and order management in financial markets, as claimed in claim 3, comprises the steps of:
providing an audio filtering algorithm; and
removing noise and attenuation from the audio input with the audio filtering algorithm with the data processing device.

10. The trading system with natural strategy processing, validation, deployment, and order management in financial markets, as claimed in claim 1, comprises the steps of:
providing a trade strategy database, a statistical mathematical model, a pre-trained neural network, and a code-block algorithm, wherein the trade strategy database, the pre-trained neural network, the statistical mathematical model, and the code-block algorithm are managed by the data processing device;
wherein the strategy input is a video input and wherein the video input includes video metadata;
converting the video metadata into a text input using a metadata identification algorithm with the data processing device, wherein the transformation algorithm includes the metadata identification algorithm, during Step D;
mapping relevant words and phrases from the text input using the statistical mathematical model, the trade strategy database and the pretrained neural network with the data processing device;
organizing the relevant words and phrases into a logical text string, with the data processing device; and
generating a customized trade-strategy code block from the logical text string through the code-block algorithm with the data processing device, during step E.

11. The trading system with natural strategy processing, validation, deployment, and order management in financial markets, as claimed in claim 1, comprises the steps of:
wherein the strategy input is an audio/video (AV) input; and
separating the AV input into an audio input and a video input.

12. The trading system with natural strategy processing, validation, deployment, and order management in financial markets, as claimed in claim 1, comprises the steps of:
providing a trade strategy database, a statistical mathematical model, a pre-trained neural network, and a code-block algorithm, wherein the trade strategy database, the pre-trained neural network, the statistical mathematical model, and the code-block algorithm are managed by the data processing device;
wherein the strategy input is an image input;
converting the image input into a text input using an optical character recognition (OCR) algorithm with the data processing device, during Step D, wherein the transformation algorithm includes the OCR algorithm;
mapping relevant words and phrases from the text input using the statistical mathematical model, the trade strategy database and the pretrained neural network with the data processing device;
organizing the relevant words and phrases into a logical text string, with the data processing device; and
generating a customized trade-strategy code block from the logical text string through the code-block algorithm with the data processing device, during step E.

13. The trading system with natural strategy processing, validation, deployment, and order management in financial markets, as claimed in claim 1, comprises the steps of:
wherein the validation algorithm includes a backtesting module, wherein the external data includes historical data, and wherein a user portfolio is managed by the data processing device;
iterating executions for the custom trade-strategy code block using the historical data to determine the performance of the custom trade-strategy code block through the backtesting module with the data processing device, during Step F;
generating a theoretical trade order from the performance of the custom trade-strategy code block with the data processing device;
amending the theoretical trade order into the user portfolio with the data processing device, during Step G; and
generating theoretical graphical representations for the performance of the custom trade-strategy code block, during Step H.

14. The trading system with natural strategy processing, validation, deployment, and order management in financial markets, as claimed in claim 1, comprises the steps of:
wherein the validation algorithm includes a forward testing module and wherein a user portfolio is managed by the data processing device;
determining the performance of the custom trade-strategy code block using the external data through the forward testing module with the data processing device, during Step F;
generating a theoretical trade order from the performance of the custom trade-strategy code block with the data processing device;
amending the theoretical trade order into the user portfolio with the data processing device, during Step G; and
generating theoretical graphical representations for the performance of the custom trade-strategy code block, during Step H.

15. The trading system with natural strategy processing, validation, deployment, and order management in financial markets, as claimed in claim 1, comprises the steps of:
wherein a user portfolio is managed by the data processing device and wherein the user portfolio includes a plurality of trade orders;
executing functions for market participation and the customized trade strategy for each trade orders with the data processing device;
generating a trade notification with the data processing device;
amending results the market participation into the user portfolio with the data processing device, during Step G; and
generating graphical representations from the market participation during Step H.

16. The trading system with natural strategy processing, validation, deployment, and order management in financial markets, as claimed in claim 15, comprises the step of:
displaying the trade notification with the data processing device.

17. The trading system with natural strategy processing, validation, deployment, and order management in financial markets, as claimed in claim 15, comprises the steps of:
providing a remote computing device, wherein the remote computing device is communicatively coupled with the data processing device;
sending the trade notification to the remote computing device from the data processing device; and
displaying the trade notification with the remote computing device.

18. The trading system with natural strategy processing, validation, deployment, and order management in financial markets, as claimed in claim 1, comprises the steps of:
providing a risk-assessment algorithm, wherein the risk-assessment algorithm is managed by the data processing device;
assessing market risk for the customized trade-strategy code block using the external data through the risk-assessment algorithm with the data processing device, prior to Step G; and
generating graphical representations from the results from the risk-assessment algorithm, during Step H.

19. The trading system with natural strategy processing, validation, deployment, and order management in financial markets, as claimed in claim 18, comprises the steps of:
providing a trade order and a set of user-defined preferences, wherein the trade order and the set of user-defined preferences are managed by the data processing device;
wherein a user portfolio is managed by the data processing device;
calculating risk metrics for the trade order from the external data through the risk-assessment algorithm with the data processing device;
comparing the risk metrics with the set of user preferences with the data processing device; and
amending the trade order into the user portfolio with the data processing device,
if the risk metrics fall within a range defined by the set of user preferences.
